(19) United States
(12) Patent Application Publication
(10) Pub. No.: US 2025/0164521 A1
(43) Pub. Date: May 22, 2025

(54) Sensor Module And Electronic Apparatus

(71) Applicant: SEIKO EPSON CORPORATION, Tokyo (JP)

(72) Inventors: Taketo CHINO, Hokuto (JP); Ryohei OZAWA, Shiojiri (JP)

(21) Appl. No.: 18/954,947

(22) Filed: Nov. 21, 2024

(30) Foreign Application Priority Data
Nov. 22, 2023 (JP) 2023-197979

(51) Int. Cl. G01P 15/18; G01D 11/24; G01P 15/14

(52) U.S. Cl. CPC G01P 15/18; G01D 11/245; G01P 15/14

(57) ABSTRACT

A sensor module includes a first substrate, a second substrate, and a connection portion forming a connection between the first substrate and the second substrate. The first substrate is provided with a first sensor device configured to detect a physical quantity on a first axis, a second sensor device configured to detect a physical quantity on a second axis, and a third sensor device configured to detect a physical quantity on a third axis. The second substrate is provided with a fourth sensor device configured to detect a physical quantity on the first axis, a fifth sensor device configured to detect a physical quantity on the second axis, and a sixth sensor device configured to detect a physical quantity on the third axis.

The present application is based on, and claims priority from JP Application Serial Number 2023-197979, filed Nov. 22, 2023, the disclosure of which is hereby incorporated by reference herein in its entirety.

### BACKGROUND

### 1. Technical Field

The present disclosure relates to a sensor module and an electronic apparatus.

### 2. Related Art

A sensor module disclosed in JP-A-2019-163955, which is an example of related art, includes two X-axis angular rate sensor devices mounted on a side surface of the same substrate to provide high-accuracy X-axis angular rate data.

Such a sensor module including more than one sensor device for one sensing axis is expected to undergo further improvements in the effectiveness and reliability of the enhanced accuracy.

### SUMMARY

A sensor module according to an aspect of the present disclosure includes a first substrate, a second substrate, and a connection portion forming a connection between the first substrate and the second substrate. The first substrate is provided with a first sensor device configured to detect a physical quantity on a first axis, a second sensor device configured to detect a physical quantity on a second axis, and a third sensor device configured to detect a physical quantity on a third axis. The second substrate is provided with a fourth sensor device configured to detect a physical quantity on the first axis, a fifth sensor device configured to detect a physical quantity on the second axis, and a sixth sensor device configured to detect a physical quantity on the third axis.

An electronic apparatus according to an aspect of the present disclosure includes the sensor module described above.

### BRIEF DESCRIPTION OF THE DRAWINGS

FIG. 1 is a perspective view of a sensor module according to Embodiment 1, illustrating a state in which the sensor module is fastened to a mounting surface.

FIG. 2 is a perspective view of the sensor module in FIG. 1 as seen from the side where the mounting surface is located.

FIG. 3 is an exploded perspective view of the sensor module.

FIG. 4 is a development view of a substrate unit.

FIG. 5 is a development view of the substrate unit.

FIG. 6 is an enlarged view as seen in the direction indicated by P in FIG. 4.

FIG. 7 is a perspective view of a fixation frame.

FIG. 8A is a sectional view taken along line VIIIA-VIIIA in FIG. 6.

FIG. 8B is a sectional view taken along line VIIIB-VIIIB in FIG. 6.

FIG. 9 is a configuration diagram of a sensor device.

FIG. 10 is a perspective view of a variation of the sensor device.

FIG. 11 is a development view of a variation of the substrate unit.

FIG. 12 is a perspective view of an example of an electronic apparatus according to Embodiment 2.

FIG. 13 is a perspective view of another example of the electronic apparatus according to Embodiment 2.

### DESCRIPTION OF EMBODIMENTS

For greater visibility, constituent elements in each drawing are not necessarily drawn to scale. The X-, Y-, and Z-axes in each drawing are orthogonal to each other. The terms “X-axis direction”, “Y-axis direction”, and “Z-axis direction” herein refer to the direction parallel to the X-axis, the direction parallel to the Y-axis, and the direction parallel to the Z-axis, respectively. The term “plus side” herein refers to each of the sides where the tips of the arrows denoting the X-, Y-, and Z-axes are located, and the term “minus side” herein refers to each of the sides where the proximal ends of the respective arrows are located. The expression “viewed in plan” herein means that a plane including the X-axis and the Y-axis is viewed in the Z-axis direction, and the expression “viewed in cross section” herein means that a cross section including the Z-axis is viewed in the X-axis direction or the Y-axis direction.

The term “upper surface” used in relation to any constituent component in the description below refers to the surface on the plus side in the Z-axis direction of the constituent component concerned. For example, an upper surface of a substrate refers to the surface on the plus side in the Z-axis direction of the substrate. The term “lower surface” used in relation to any constituent component in the description below refers to the surface on the minus side in the Z-axis direction of the constituent component concerned.

### 1. Embodiment 1

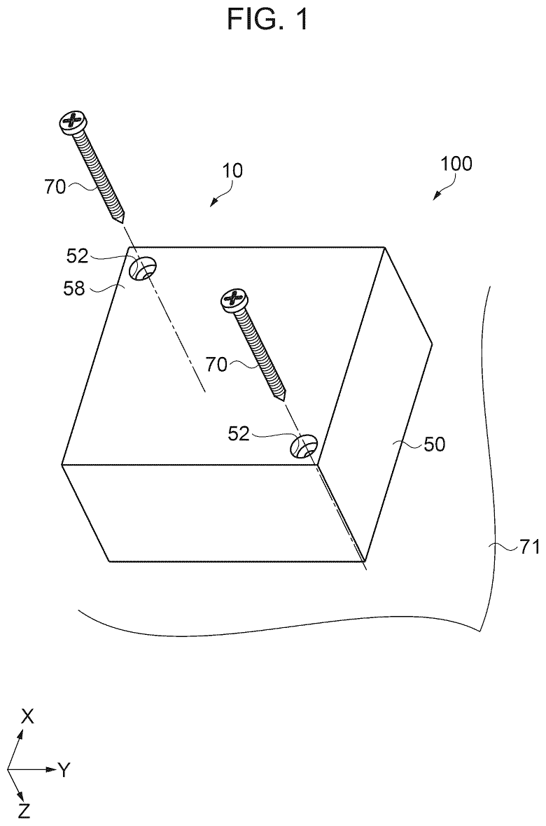

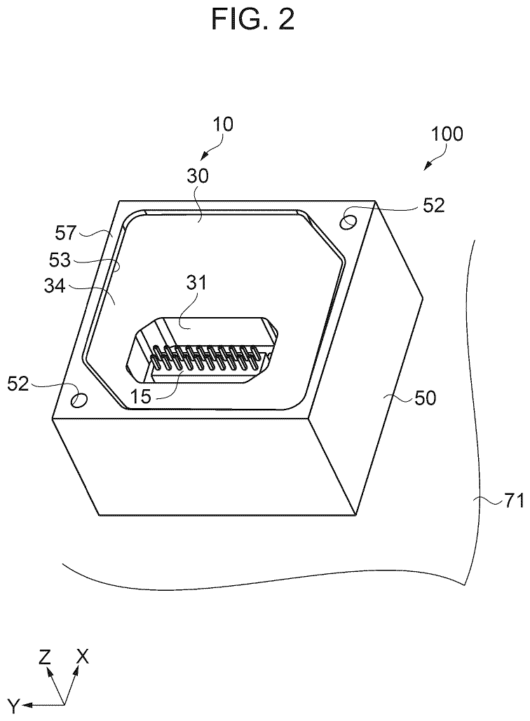

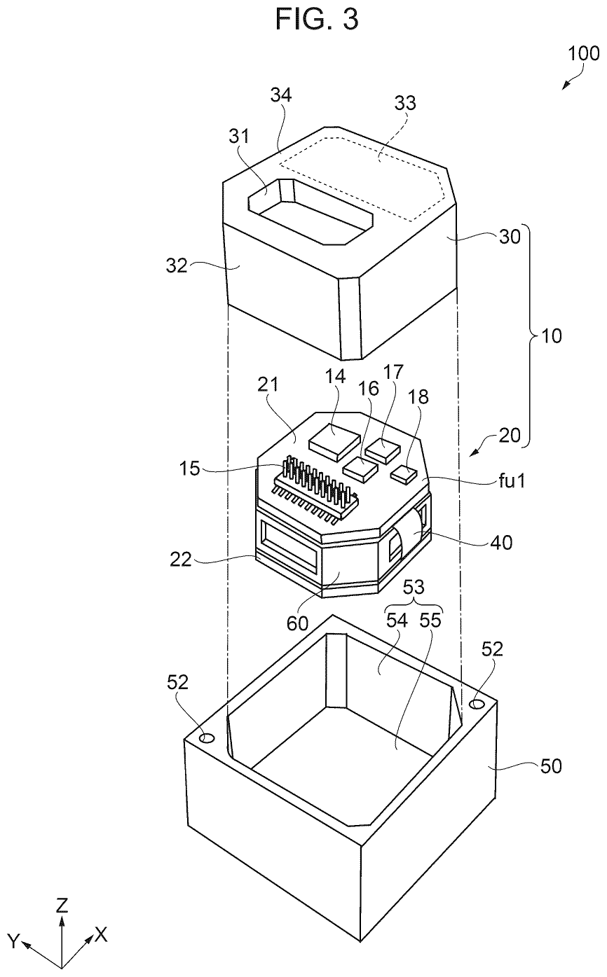

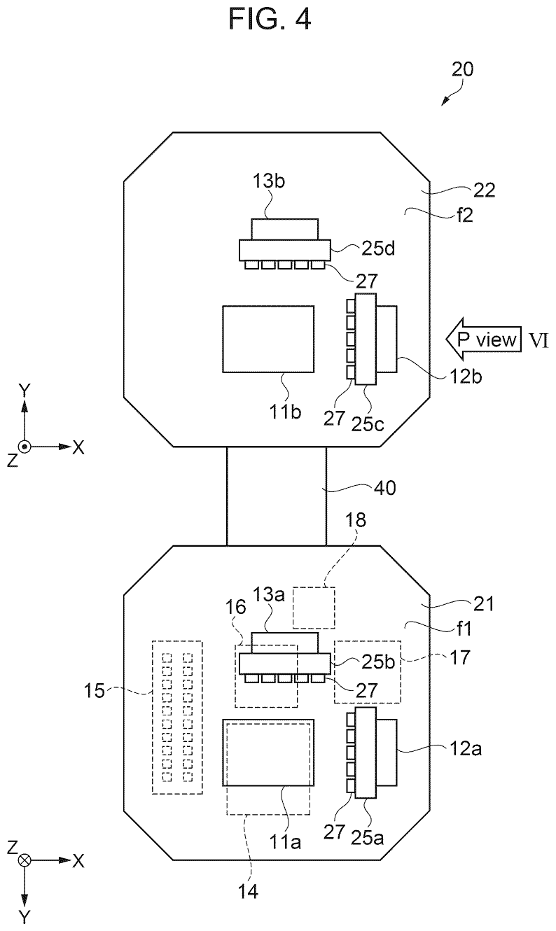

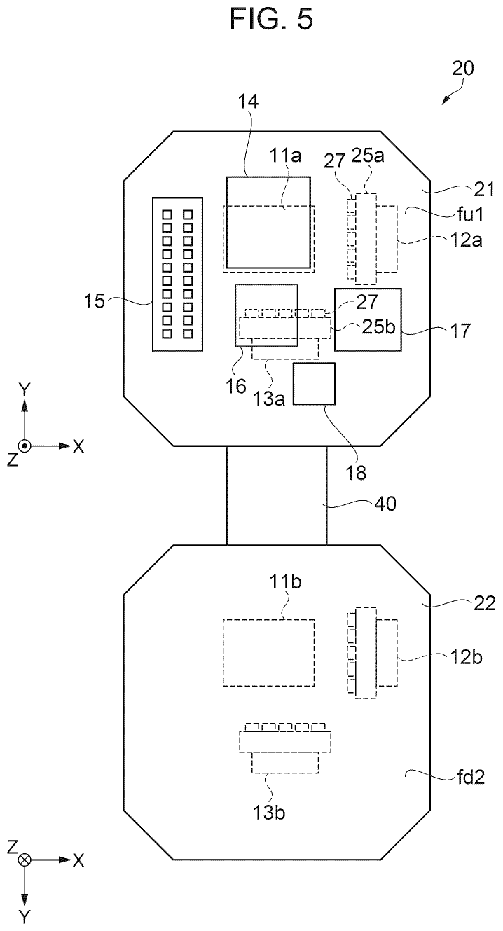

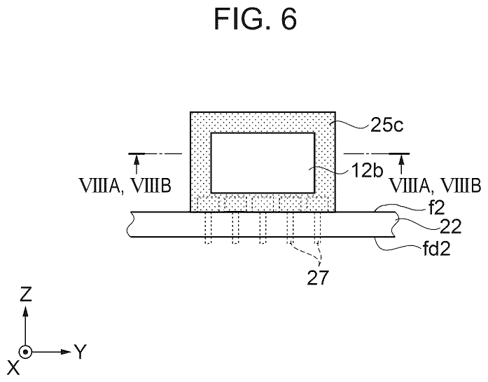

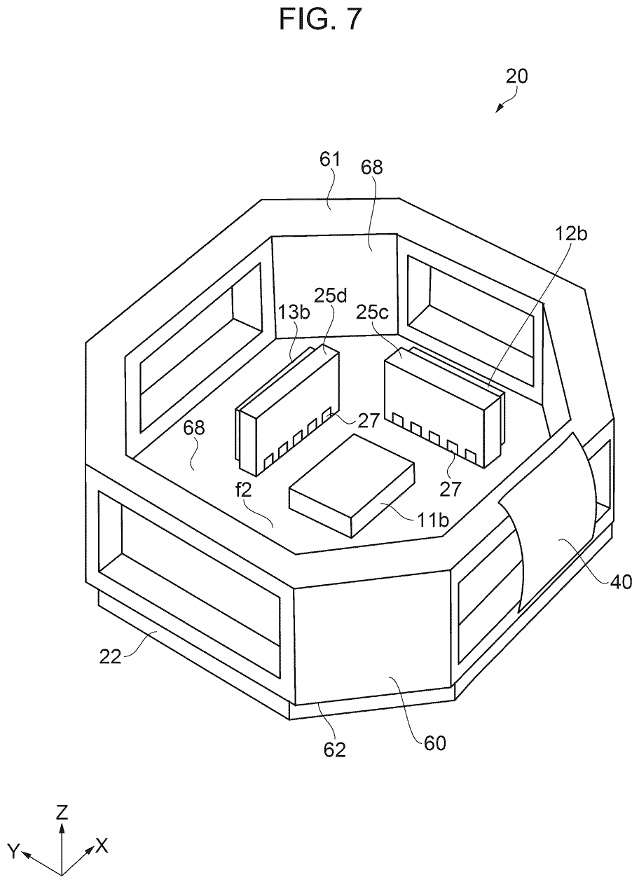

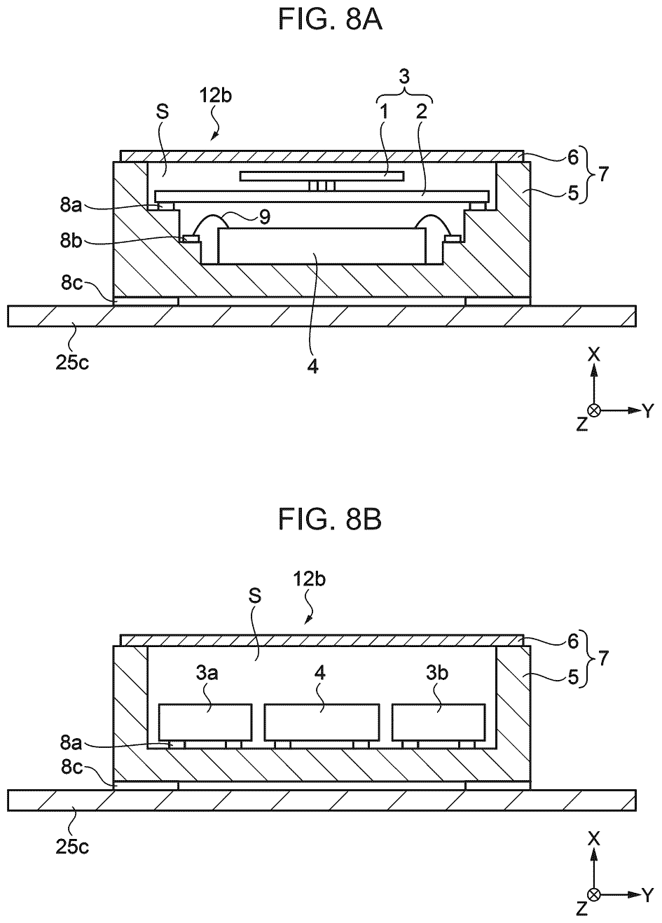

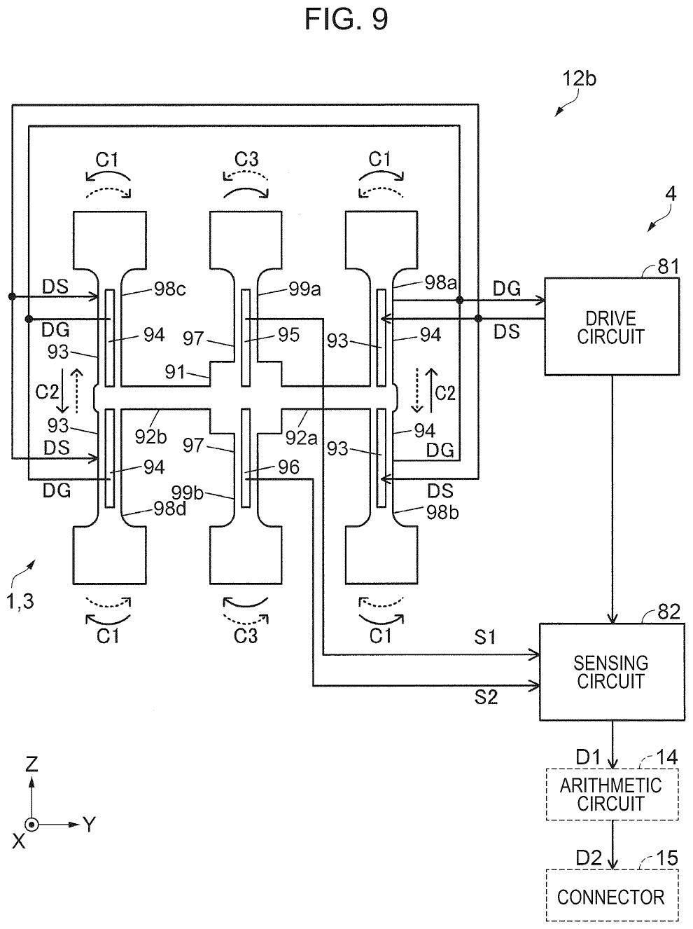

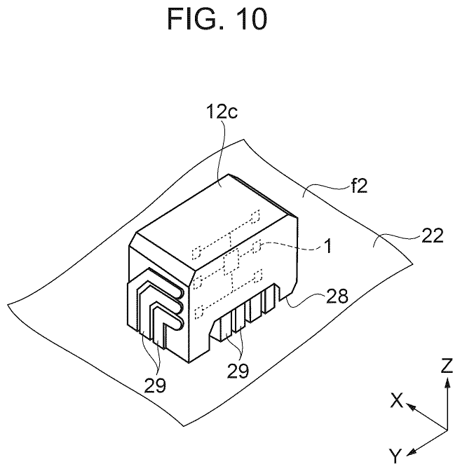

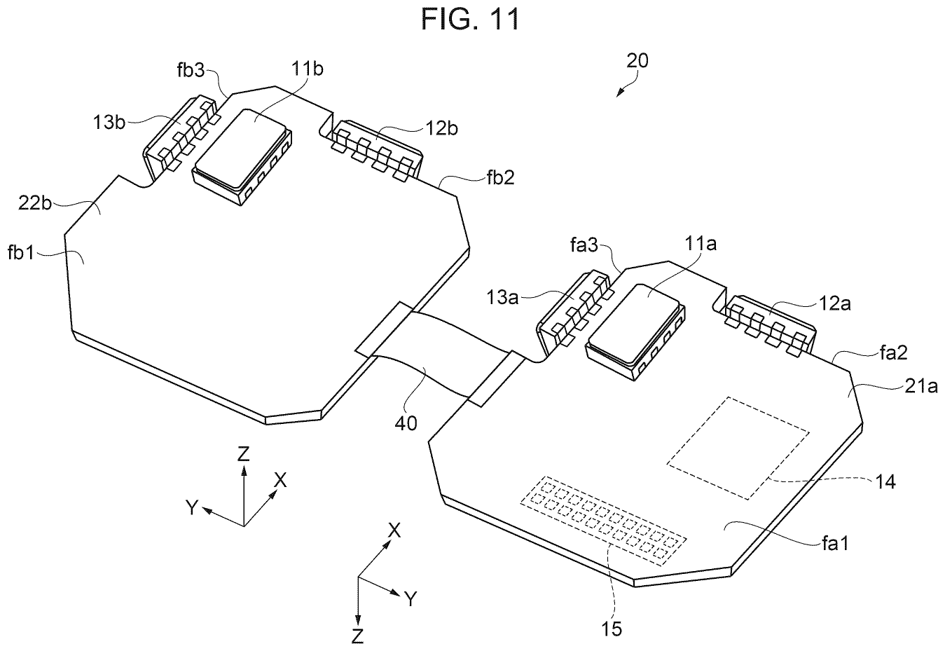

FIGS. 1 to 11 illustrate a sensor module 100 according to Embodiment 1. FIG. 1 is a perspective view of the sensor module 100 and illustrates a state in which the sensor module 100 is fastened to a mounting surface 71, which is a surface of, for example, an automobile. FIG. 2 is a perspective view of the sensor module 100 in FIG. 1 as seen from the side where the mounting surface 71 is located. FIG. 3 is an exploded perspective view of the sensor module 100. FIG. 4 is a development view of a substrate unit 20. FIG. 5 is a development view of the substrate unit 20. FIG. 6 is an enlarged view as seen in the direction indicated by P in FIG. 4. FIG. 7 is a perspective view of a fixation frame 60. FIG. 8A is a sectional view taken along line VIIIA-VIIIA in FIG. 6 and illustrates an example of a sensor device 12b. FIG. 8B is a sectional view taken along line VIIIB-VIIIB in FIG. 6 and illustrates another example of the sensor device 12b. FIG. 9 is an explanatory diagram illustrating the internal configuration of the sensor device. FIG. 10 is a perspective view of a variation of the sensor device. FIG. 11 is a development view of a variation of the substrate unit 20.

The sensor module 100 according to the present embodiment is an inertial measurement unit (IMU) configured to detect the orientation and behavior of an automobile, a robot, or any other apparatus on which the sensor module 100 is mounted. The apparatus may also be regarded as a moving object. The behavior may also be regarded as inertial momentum.

As illustrated in FIG. 1, the sensor module 100 includes an outer case 50, which is substantially square in shape when viewed in plan. The three-dimensional shape of the outer case 50 is a rectangular parallelepiped. For example, the sensor module 100 has square surfaces each side of which is about 24 mm, and the thickness of the sensor module 100 is about 10 mm.

The outer case 50 houses the substrate unit 20, on which more than one sensor device is mounted. The substrate unit 20 will be described later. The outer case 50 has a lower surface 58, where two threaded holes 52 are provided. The sensor module 100 is to be used in a state in which it is fastened to the mounting surface 71 of the apparatus of interest (e.g., an automobile) with two screws 70 inserted into the respective threaded holes 52.

As illustrated in FIG. 2, an inner case 30 fits in an interior 53 under an upper surface 57 of the outer case 50. The inner case 30 has an upper surface 34, where a cavity 31 is provided. A connector 15, which is a plug-type connector, is disposed in the cavity 31.

The connector 15 includes multiple pins. A socket-type connector (not illustrated) of the apparatus of interest is connected to the connector 15. The sensor module 100 is supplied with power by a power supply circuit of the apparatus through the connector 15 so that the sensor module 100 can transmit electrical signals (e.g., sensing data) to the apparatus.

### 1.1. Configuration of Sensor Module

FIG. 3 is an exploded perspective view of the sensor module 100 illustrated in FIG. 2. As illustrated in FIG. 3, the sensor module 100 includes the outer case 50 and a sensor unit 10, which is housed in the outer case 50.

The outer case 50 is a machined aluminum base in the form of a box. The material of the outer case 50 is not limited to aluminum. For example, the outer case 50 may be made of zinc, stainless steel, or any other metal or may be made of a composite material containing metal and resin.

The outer case 50 is in the form of a lidless box. The interior 53 of the outer case 50 is an internal space surrounded with a bottom surface 55 and a side wall 54. The sensor unit 10 fits in the internal space of the outer case 50 with a bonding member disposed therebetween.

The sensor unit 10 includes the inner case 30 and the substrate unit 20 housed in the inner case 30. The inner case 30 is a member that holds the substrate unit 20 and is shaped to fit in the interior 53 of the outer case 50. When viewed in plan, the inner case 30 has an octagonal shape where four corners at the vertices of a square are chamfered. The upper surface of the inner case 30 has the cavity 31, which is a through-hole. The inner case 30 has a recess 33 therein.

The height of a side wall 32 of the inner case 30 is less than the height of the side wall 54 of the outer case 50. As illustrated in FIG. 2, the upper surface 34 of the inner case 30 is at a level below the upper surface 57 of the outer case 50. A guide pin or a support surface (not illustrated) for positioning the substrate unit 20 is provided in the inner case 30. The substrate unit 20 is positioned with the aid of the guide pin or the support surface and is fastened in place inside the inner case 30 with a bonding member.

### 1.2. Configuration of Substrate Unit

FIG. 4 is a development view of the substrate unit 20, illustrating a state in which the substrate unit 20 is unfolded to expose a main surface f1 of a substrate 21 and a main surface f2 of a substrate 22 to view. FIG. 5 is a development view of the substrate unit 20, illustrating a state in which the substrate unit 20 in FIG. 4 is seen from the opposite side where an upper surface fu1 of the substrate 21 and a lower surface fd2 of the substrate 22 are exposed to view. Referring to FIGS. 4 and 5, the X-, Y-, and Z-axes are the coordinate axes of the substrate unit 20 in the assembled state, and each coordinate axis of the substrate 21 and the corresponding coordinate axis of the substrate 22 point to different directions. The substrate unit 20 in actual use is assembled as illustrated in FIGS. 3 and 7. When being in the assembled state, the substrate unit 20 in the present embodiment is supported by the fixation frame 60 and is substantially a rectangular parallelepiped.

The substrate unit 20 in the present embodiment includes substrates respectively denoted by 21 and 22, a flexible substrate 40, sensor devices respectively denoted by 11a, 12a, 13a, 11b, 12b, and 13b, an arithmetic circuit 14, a connector 15, a memory 16, a power supply circuit 17, and a temperature sensor 18.

The substrates 21 and 22 are rigid substrates or, more specifically, glass epoxy substrates. The substrates 21 and 22 may be other kinds of rigid substrates, such as composite substrates or ceramic substrates. The substrates 21 and 22 each may be a multilayer structure or a monolayer structure.

The flexible substrate 40 is softer than the substrates 21 and 22. The flexible substrate 40 is disposed between the substrate 21 and the substrate 22 and forms an electrical connection between the substrate 21 and the substrate 22. The flexible substrate 40 in the present embodiment is used to suppress mechanical or electrical interference between the sensor devices. The flexible substrate 40 may be a flexible wiring cable (e.g., a flat cable), a flexible wiring cord (e.g., a flat cord), or a flexible wire.

The substrate 21, the substrate 22, and the flexible substrate 40 may be a rigid-flexible substrate. In this case, the rigid-flexible substrate includes two rigid sections and one flexible section. The two rigid sections are the substrates 21 and 22 in the present embodiment, and the one flexible sections is the flexible substrate 40 in the present embodiment.

The arithmetic circuit 14, the connector 15, the memory 16, the power supply circuit 17, and the temperature sensor 18 are mounted on the upper surface fu1 of the substrate 21. Additional electronic components are mounted on the upper surface fu1 of the substrate 21.

The arithmetic circuit 14 serves as a primary controller for the sensor devices 11a, 12a, 13a, 11b, 12b, and 13b. The arithmetic circuit 14 is an integrated circuit device and may, for example, be configured as a microprocessor unit (MPU) or a central processing unit (CPU).

The arithmetic circuit 14 receives sensing data output from the sensor devices 11a, 12a, 13a, 11b, 12b, and 13b. The arithmetic circuit 14 then executes various kinds of processing and outputs the resultant sensing data to the outside through the connector 15.

Examples of the various kinds of processing to be performed by the arithmetic circuit 14 include: processing for obtaining a mean value of the angular rate about the Z-axis on the basis of the data provided by the sensor devices 11a and 11b; processing for obtaining a mean value of the angular rate about the X-axis on the basis of the data provided by the sensor devices 12a and 12b; processing for obtaining a mean value of the angular rate about the Y-axis on the basis of the data provided by the sensor devices 13a and 13b; processing for making corrections to each of the obtained mean values by implementing, for example, temperature correction or zero point correction; processing for sensitivity adjustment; filter processing; and the processing for outputting the resultant sensing data through the connector 15. The arithmetic circuit 14 is an example of a processing unit. The processing for obtaining a mean value of the angular rate about each axis is an example of desired processing.

The connector 15 is a plug-type connector including two rows of connection terminals arranged with a constant pitch in the Y-axis direction. The connector 15 in the present embodiment includes twenty pins arranged in two rows, with ten pins in each row. The number of terminals may be changed as appropriate in accordance with design specifications.

The memory 16 is the location of storage of programs and data, such as programs for various kinds of processing to be executed by the arithmetic circuit 14, programs for incorporating the processed sensing data into packet data, and data necessary for execution of the programs (e.g., table data for temperature correction processing).

The power supply circuit 17 is supplied with power by the apparatus of interest and provides necessary power to, for example, the sensor devices 11a, 12a, 13a, 11b, 12b, and 13b and the arithmetic circuit 14. The temperature sensor 18 outputs temperature information to the arithmetic circuit 14, which executes the temperature correction processing by using the temperature information.

### 1.3. Sensor Device

Each of the sensor devices 11a, 11b, 12a, 12b, 13a, and 13b in the present embodiment is a vibration gyro sensor that includes quartz crystal serving as a vibrator and detects the angular rate on the basis of the Coriolis force applied to the vibrator. It is not required that the vibrator be quartz crystal. For example, the vibrator may be a micro-electro-mechanical systems (MEMS) vibrator including a silicon substrate.

The sensor devices 11a and 11b are Z-axis angular rate sensors that detect the angular rate about the Z-axis. The driving frequency of the sensor device 11a is equal to the driving frequency of the sensor device 11b and is, for example, 49.6 kHz. The driving frequency of the sensor devices 11a and 11b is an example of a first driving frequency. The driving frequency is described in Section 1.7.2.

The sensor devices 12a and 12b are X-axis angular rate sensors that detect the angular rate about the X-axis. The driving frequency of the sensor device 12a is equal to the driving frequency of the sensor device 12b and is, for example, 51.0 kHz. The driving frequency of the sensor devices 12a and 12b is an example of a second driving frequency.

The sensor devices 13a and 13b are Y-axis angular rate sensors that detect the angular rate about the Y-axis. The driving frequency of the sensor device 13a is equal to the driving frequency of the sensor device 13b and is, for example, 53.6 kHz. The driving frequency of the sensor devices 13a and 13b is an example of a third driving frequency.

The sensor devices 11a, 12a, and 13a are mounted on the main surface f1 of the substrate 21. The sensor devices 11b, 12b, and 13b are mounted on the main surface f2 of the substrate 22. That is, the substrate 21 is the mounting place for three sensor devices configured to be driven at different driving frequencies and respectively denoted by 11a, 12a, and 13a, and the substrate 22 is the mounting place for three sensor devices configured to be driven at different driving frequencies and respectively denoted by 11b, 12b, and 13b.

The sensor module 100 in the present embodiment includes two Z-axis angular rate sensors, two X-axis angular rate sensors, and two Y-axis angular rate sensors. Accordingly, high-accuracy angular data can be obtained for the respective axes. The two respective angular rate sensors for each axis are disposed on different substrates, with one on the substrate 21 and the other on the substrate 22. This precludes the possibility of interference between the angular rate sensors for the same axis and can thus yield improvements in the effectiveness of the enhanced accuracy of the angular rate data about each axis. The three angular rate sensors disposed on the substrate 21 are configured to be driven at different driving frequencies. Likewise, the three angular rate sensors disposed on the substrate 22 are configured to be driven at different driving frequencies. Thus, the three angular rate sensors on each of the substrates 21 and 22 are less likely to interfere with each other. This can yield improvements in the effectiveness of the enhanced accuracy of the angular rate data about each axis.

The two Z-axis angular rate sensors are configured to be driven at the same driving frequency. The present embodiment can effect savings in cost related to, for example, manufacturing, ordering, inventory, or assembly of the sensor devices 11a and 11b configured to be driven at different driving frequencies and thus provides the sensor module 100 with added value for industrial use. The same holds true for the X-axis angular rate sensors and the Y-axis angular rate sensors.

### 1.4. Relay Substrate

As illustrated in FIG. 6, the sensor device 12b is mounted on the main surface f2 of the substrate 22 in the state in which the sensor device 12b is mounted on a relay substrate 25c. The relay substrate 25c is a size larger than the sensor device 12b that is rectangular in shape when viewed in plan. The relay substrate 25c is disposed orthogonal to the substrate 22. Like the substrate 22, the relay substrate 25c is a rigid substrate, such as a glass epoxy substrate.

The sensor device 12b is mounted on the plus side in the X-axis direction of the relay substrate 25c, and pin headers 27 are mounted on the minus side in the X-axis direction of the relay substrate 25c.

The pin headers 27 are rod-shaped metal components for connecting two substrates to each other. The ends of the pins are inserted into via-holes in the substrate 22 and are soldered thereto.

Provided with the pin headers 27, the relay substrate 25c is mounted upright on the substrate 22. The long sides of the rectangular shape of the relay substrate 25c are parallel to the Y-axis. That is, the sensor device 12b is oriented perpendicular to its sensing axis, namely, the X-axis.

The pin headers 27 also serve as electrical wiring between the relay substrate 25c and the substrate 22; that is, the sensing data and the driving voltage of the sensor device 12b are transmitted to and received from the substrate 22 through the pin headers 27. Any means by which the relay substrate 25c can be mounted orthogonal to the substrate 22 may be used as a substitute for the pin headers 27. For example, terminals for on-board placement may be provided on a side surface of the relay substrate 25c. Alternatively, L-shaped metal fittings may be used as a substitute for the pin headers 27.

The sensor device 13b is disposed on the main surface f2 of the substrate 22 in the state in which the sensor device 13b is mounted on a relay substrate 25d. The relay substrate 25d is similar to the relay substrate 25c; that is, the relay substrate 25d is disposed orthogonal to the substrate 22. Provided with pin headers 27, the relay substrate 25d is mounted upright on the substrate 22. The long sides of the rectangular shape of the relay substrate 25d are parallel to the X-axis. That is, the sensor device 13b is oriented perpendicular to its sensing axis, namely, the Y-axis.

The sensor device 12a is disposed on the main surface f1 of the substrate 21 in the state in which the sensor device 12a is mounted on a relay substrate 25a. The relay substrate 25a is similar to the relay substrate 25c; that is, the relay substrate 25a is disposed orthogonal to the substrate 21. Provided with pin headers 27, the relay substrate 25a is mounted upright on the substrate 21. The long sides of the rectangular shape of the relay substrate 25a are parallel to the Y-axis. That is, the sensor device 12a is oriented perpendicular to its sensing axis, namely, the X-axis.

The sensor device 13a is disposed on the main surface f1 of the substrate 21 in the state in which the sensor device 13a is mounted on a relay substrate 25b. The relay substrate 25b is similar to the relay substrate 25c; that is, the relay substrate 25b is disposed orthogonal to the substrate 21. Provided with pin headers 27, the relay substrate 25b is mounted upright on the substrate 21. The long sides of the rectangular shape of the relay substrate 25b are parallel to the X-axis. That is, the sensor device 13a is oriented perpendicular to its sensing axis, namely, the Y-axis.

In the present embodiment, the substrate 21 is an example of a first substrate, and the main surface f1 is an example of a first surface. The substrate 22 is an example of a second substrate, and the main surface f2 is an example of a second surface. The sensor device 11a is an example of a first sensor device, and the angular rate about the Z-axis is an example of a physical quantity on a first axis. The sensor device 12a is an example of a second sensor device, and the angular rate about the X-axis is an example of a physical quantity on a second axis. The sensor device 13a is an example of a third sensor device, and the angular rate about the Y-axis is an example of a physical quantity on a third axis. The sensor device 11b is an example of a fourth sensor device. The sensor device 12b is an example of a fifth sensor device. The sensor device 13b is an example of a sixth sensor device. The arithmetic circuit 14 is an example of a processing unit. The relay substrate 25a is an example of a first relay substrate. The relay substrate 25b is an example of a second relay substrate. The relay substrate 25c is an example of a third relay substrate. The relay substrate 25d is an example of a fourth relay substrate.

### 1.5. Fixation Frame

FIG. 7 is a perspective view of the fixation frame 60, illustrating a state in which the substrate unit 20 is attached to the fixation frame 60. For convenience of illustration, the substrate 21 is omitted from FIG. 7. The fixation frame 60 is in the shape of an octagonal cylinder when viewed in plan. The substrate 21 is attached to an upper surface 61 of the fixation frame 60 so that a cavity 68 on the plus side in the Z-axis direction is closed with the substrate 21. The substrate 22 is attached to a lower surface 62 of the fixation frame 60 so that a cavity 68 on the minus side in the Z-axis direction is closed with the substrate 22.

The main surface f1 of the substrate 21 and the main surface f2 of the substrate 22 are located opposite each other. The sensor devices 11a, 12a, 13a, 11b, 12b, and 13b are disposed between the substrate 21 and the substrate 22. This layout provides improved shielding against external noise.

The fixation frame 60 is made of, for example, resin. The elastic modulus of the fixation frame 60 is preferably lower than the elastic modulus of each of the substrates 21 and 22 and is preferably higher than the elastic modulus of the flexible substrate 40.

The fixation frame 60 having an elastic modulus lower than the elastic modulus of each of the substrates 21 and 22 can suppress mechanical or electrical interference between the sensor devices 11a, 12a, 13a, 11b, 12b, and 13b operating simultaneously.

The fixation frame 60 having an elastic modulus higher than the elastic modulus of the flexible substrate 40 enables the substrates 21 and 22 to be kept in desired positions corresponding to the sensing axes of the sensor devices mounted on the respective substrates. This eliminates or reduces the possibility that the substrates 21 and 22 will move out of the respective desired positions.

The substrate unit 20 in the present embodiment is fixed to the fixation frame 60 during assembly; nevertheless, it is not required that the fixation frame 60 be used for the fixation of the substrate unit 20. For example, the substrate unit 20 may be fixed directly to the inner case 30 without the use of the fixation frame 60.

### 1.6. Packaging

FIGS. 8A and 8B are sectional views taken along line VIIIA/VIIIB-VIIIA/VIIIB in FIG. 6 and are provided for the purpose of explaining the sensor device 12b. The sensor device 12b in the present embodiment may be a physical quantity sensor configured to detect the angular rate about the X-axis, as illustrated in FIG. 8A. Alternatively, the sensor device 12b may be a multi-physical quantity sensor configured to detect the angular rate about the X-axis and the acceleration along the X-axis, as illustrated in FIG. 8B.

The sensor device 12b includes a package 7, a sensor element 3, and a circuit element 4 as illustrated in FIG. 8A, or the sensor device 12b includes a package 7, a sensor element 3a, a sensor element 3b, and a circuit element 4 as illustrated in FIG. 8B. The sensor element 3 or the sensor elements 3a and 3b as well as the circuit element 4 are housed in the package 7. The sensor devices 11a, 12a, 13a, 11b, and 13b (not individually illustrated) are structurally identical to the sensor device 12b. The package 7 includes a base 5 and a lid 6. The base 5 has a recess where the base 5 is open on the plus side in the X-axis direction. The lid 6 is bonded to the base 5 with a bonding member disposed therebetween, in which state the opening at the top of the recess is closed with the lid 6. The recess defines an internal space S within the package 7.

The package 7 is, for example, a ceramic package. The base 5 is made of a ceramic material, such as alumina. The lid 6 is made of a ceramic material, such as alumina, or is made of a metallic material, such as Kovar.

The sensor element 3 and the circuit element 4 of the sensor device 12b illustrated in FIG. 8A are disposed in the internal space S. The sensor element 3 is an angular rate sensor that detects the angular rate about the X-axis. The sensor element 3 includes a vibrator 1 and a support substrate 2. The vibrator 1 is a quartz crystal vibrator. The circuit element 4 includes a sensing circuit that will be described later.

The internal space S is airtight. The internal space S is under a reduced pressure and is preferably close to a vacuum. This improves the vibration characteristics of the vibrator 1. However, the atmosphere of the internal space S is not limited to a particular atmosphere.

The vibrator 1, the support substrate 2, and the circuit element 4 overlap each other in the internal space S when viewed in plan. This enables miniaturization of the sensor device 12b, without an extra increase in the dimension of the package 7 along a plane extending in the Y-axis and/or Z-axis direction.

Internal terminals 8a and internal terminals 8b are disposed in the recess of the base 5, and external terminals 8c are disposed on a surface on the minus side in the X-axis direction of the base 5. The internal terminals 8a, the internal terminals 8b, and the external terminals 8c are electrically connected to wiring (not illustrated) in the base 5 and on the relay substrate 25c. The internal terminals 8a are electrically connected to the sensor element 3 with a conductive bonding member therebetween, and the internal terminals 8b are electrically connected to the circuit element 4 with bonding wires 9 therebetween.

The sensor element 3a, the sensor element 3b, and the circuit element 4 of the sensor device 12b illustrated in FIG. 8B are disposed in the internal space S. The sensor element 3a is an angular rate sensor that detects the angular rate about the X-axis. Like the sensor element 3, the sensor element 3a includes a vibrator capable of producing flexural vibration and detects the angular rate on the basis of the Coriolis force.

The sensor element 3b is an acceleration sensor that detects the acceleration along the X-axis. The sensor element 3b includes a quartz crystal vibrator and detects the acceleration on the basis of changes in the vibration frequency of the quartz crystal vibrator. In some embodiments, the sensor element 3b includes a silicon MEMS and is configured to detect the acceleration on the basis of changes in the capacitance between a fixed electrode and a movable electrode that are comb teeth-shaped electrodes of the MEMS.

The sensor device 12b is not limited to the one illustrated in FIG. 8B, in which the sensor device 12b includes an angular rate sensor configured to detect the angular rate about the X-axis and an acceleration sensor configured to detect the acceleration along the X-axis. For example, the sensor device 12b may include, in addition to the sensor elements 3a and 3b, an angular rate sensor element configured to detect the angular rate about the Z-axis and/or an angular rate sensor element configured to detect the angular rate about the Y-axis. Alternatively, the sensor device 12b may include, in addition to the sensor elements 3a and 3b, an acceleration sensor element configured to detect the acceleration along the Z-axis and/or an acceleration sensor element configured to detect the acceleration along the Y-axis. The sensor element 3a may, for example, be a three-axis angular rate sensor configured to detect the angular rate about each of the X-, Y-, and Z-axes. The sensor element 3b may, for example, be a three-axis acceleration sensor configured to detect the acceleration along each of the X-, Y-, and Z-axes. The sensor element 3b may, for example, be an angular rate sensor configured to detect the angular rate about the Z-axis or the Y-axis or may be a three-axis angular rate sensor configured to detect the angular rate about each of the X-, Y-, and Z-axes. For example, the sensor element 3a may be a three-axis angular rate sensor configured to detect the angular rate about each of the X-, Y-, and Z-axes, and the sensor element 3b may be a three-axis acceleration sensor configured to detect the acceleration along each of the X-, Y-, and Z-axes. In other words, the sensor device 12b may be a three-axis angular sensor, a three-axis acceleration sensor, or a six degrees of freedom (6DoF) sensor.

When being a ceramic package, the package 7 may be regarded as a rigid substrate. In this case, the sensor elements 3, 3a, and 3b may be regarded as the sensor device 12b. When being a ceramic package, the package 7 may be mounted directly on the flexible substrate.

### 1.7. Sensor Element and Circuit Element

### 1.7.1. Configuration

FIG. 9 illustrates detailed example configurations of the sensor element 3 and the circuit element 4 of the sensor device 12b in FIG. 8A. The sensor devices 11a, 12a, 13a, 11b, and 13b are configurationally identical to the sensor device 12b.

The sensor device 12b includes the sensor element 3 and the circuit element 4. The sensor element 3 includes the vibrator 1, and the circuit element 4 includes a drive circuit 81 and a sensing circuit 82.

The drive circuit 81 may include: an amplifier circuit that amplifies a feedback signal DG input from the vibrator 1; an automatic gain control (AGC) circuit that performs automatic gain control; and an output circuit that outputs a drive signal DS to the vibrator 1. The AGC circuit variably and automatically adjusts the gain so that the amplitude of the feedback signal DG from the vibrator 1 is maintained constant. The output circuit outputs the drive signal DS to the vibrator 1. For example, the drive signal DS is in the form of a rectangular wave.

The sensing circuit 82 may include, for example, an amplifier circuit, a synchronous detection circuit, and an A/D conversion circuit. The amplifier circuit receives sensing signals S1 and S2, which are differential signals from the vibrator 1. The amplifier circuit performs charge-to-voltage conversion on the sensing signals S1 and S2 and amplifies the sensing signals S1 and S2. The synchronous detection circuit performs synchronous detection using a synchronizing signal from the drive circuit 81 to extract a desired wave. After undergoing synchronous detection, the sensing signals S1 and S2 in analog form are converted into sensing data D1 in digital form by the A/D conversion circuit, which then outputs the sensing data D1 to the arithmetic circuit 14.

The arithmetic circuit 14 performs various kinds of processing, such as temperature correction, zero point correction, sensitivity adjustment, filter processing, on the sensing data D1. The arithmetic circuit 14 then outputs the resultant data, namely, sensing data D2 to the outside through the connector 15.

The vibrator 1 in the present embodiment is a double T-shaped vibrator. Alternatively, the vibrator 1 may, for example, be a tuning fork vibrator or an H-shaped vibrator. The vibrator 1 includes drive arms respectively denoted by 98a, 98b, 98c, and 98d, sensing arms respectively denoted by 99a and 99b, a base 91, and linking arms respectively denoted by 92a and 92b.

The base 91 is rectangular in shape. Each of the sensing arm 99a, the sensing arm 99b, the linking arm 92a, and the linking arm 92b is provided on the corresponding one of the sides of the base 91. The drive arm 98a and the drive arm 98b are provided to the respective tip portions of the linking arm 92a. The drive arm 98c and the drive arm 98d are provided to the respective tip portions of the linking arm 92b.

The drive arms 98a, 98b, 98c, and 98d and the sensing arms 99a and 99b have weighting portions for frequency adjustment at their respective tips. Provided that the thickness direction of the vibrator 1 is the X-axis direction, the vibrator 1 detects the angular rate about the X-axis.

The drive arms 98a and 98b each have drive electrodes 93 formed on their surfaces on the plus side and the minus side in the X-axis direction. The drive arms 98a and 98b each have drive electrodes 94 formed on their surfaces on the plus side and the minus side in the Y-axis direction. The drive arms 98c and 98d each have drive electrodes 94 formed on their surfaces on the plus side and the minus side in the X-axis direction. The drive arms 98c and 98d each have drive electrodes 93 formed on their surfaces on the plus side and the minus side in the Y-axis direction.

The drive electrodes 93 and 94 are electrically connected to the drive circuit 81. The drive circuit 81 supplies the drive signal DS to the drive electrodes 93 and receives the feedback signal DG from the drive electrodes 94.

The sensing arm 99a has sensing electrodes 95 formed on its surfaces on the plus side and the minus side in the X-axis direction. The sensing arm 99a has ground electrodes 97 formed on its surfaces on the plus side and the minus side in the Y-axis direction. The sensing arm 99b has sensing electrodes 96 formed on its surfaces on the plus side and the minus side in the X-axis direction. The sensing arm 99b has ground electrodes 97 formed on its surfaces on the plus side and the minus side in the Y-axis direction. The sensing electrodes 95 and the sensing electrodes 96 are electrically connected to the sensing circuit 82. The sensing signals S1 and S2 from the sensing electrodes 95 and 96 are input to the sensing circuit 82.

### 1.7.2. Operation

The following describes how the sensor element 3 and the circuit element 4 operate. The drive circuit 81 applies the drive signal DS to the drive electrodes 93 such that the drive arms 98a, 98b, 98c, and 98d produce flexural vibration due to the inverse piezoelectric effect as indicated by arrows C1. Specifically, the tip of the drive arm 98a and the tip of the drive arm 98c alternately move close to and away from each other. Likewise, the tip of the drive arm 98b and the tip of the drive arm 98d alternately move close to and away from each other.

In other words, the drive arms 98a, 98b, 98c, and 98d repeat the vibration pattern indicated by solid arrows C1 and the vibration pattern indicated by dotted arrows C1 at a predetermined frequency. The predetermined frequency is, for example, 51.0 KHz.

In the present embodiment, the frequency at which the drive arms 98a, 98b, 98c, and 98d produce flexural vibration is an example of the driving frequency of the sensor device 12b. The frequency at which the drive arms 98a, 98b, 98c, and 98d produce flexural vibration may be defined by the frequency of the drive signal DS. The reason for this is that there is a correlation between the frequency of the drive signal DS and the frequency at which the drive arms 98a, 98b, 98c, and 98d produce flexural vibration. Likewise, the driving frequency of the sensor device 12b may be defined by a signal having a correlation with the frequency at which the drive arms 98a, 98b, 98c, and 98d produce flexural vibration.

The flexural vibration of the drive arms 98a and 98b and the flexural vibration of the drive arms 98c and 98d are mirror images of each other with respect to the X-axis passing through the center of gravity of the base 91. Thus, the base 91, the linking arm 92a, the linking arm 92b, the sensing arm 99a, and the sensing arm 99b hardly vibrate despite the flexural vibration of the drive arms 98a, 98b, 98c, and 98d.

In this state, the vibrator 1 undergoes the angular displacement about the X-axis such that a Coriolis force acts on the drive arms 98a, 98b, 98c, and 98d, which in turn vibrate as indicated by arrows C2. In other words, a Coriolis force acts on the drive arms 98a, 98b, 98c, and 98d in the directions of the arrows C2 orthogonal to the arrows C1 and the X-axis such that vibration components in the directions of the arrows C2 are generated.

The vibration indicated by the arrows C2 is transmitted to the base 91 through the linking arm 92a and the linking arm 92b, and as a result, the sensing arm 99a and the sensing arm 99b produce flexural vibration in the direction of arrows C3. Charge signals are generated by the piezoelectric effect produced by the flexural vibration of the sensing arms 99a and 99b and are input to the sensing circuit 82 as the sensing signals S1 and S2. In this way, the angular rate about the X-axis is detected.

### 1.8. Variations

### 1.8.1. Variation 1

FIG. 10 is a perspective view of a sensor device 12c, which is a variation of the sensor devices 12a, 12b, 13a, and 13b. The sensor devices 12a, 12b, 13a, and 13b each may be replaced with the sensor device 12c.

As illustrated in FIG. 10, the sensor device 12c includes a vibrator 1, which is mounted in vertical orientation within the sensor device 12c. The vibrator 1 mounted in vertical orientation means that the vibrator 1 is oriented perpendicular to the sensing axis, namely, the X-axis. The vibrator 1 is disposed orthogonal to a main surface f2, which is a mounting surface of the sensor device 12c. The state of being packaged in such an orientation is called vertical package. Mounting terminals 29 are disposed on a surface 28, which is the mounting surface of the sensor device 12c.

### 1.8.2. Variation 2

FIG. 11 is a development view of a variation of the substrate unit 20. In Variation 2, a substrate 21a has a main surface fa1, a side surface fa2, and a side surface fa3, which are perpendicular to the Z-axis, the X-axis, and the Y-axis, respectively. The sensor device 11a is disposed on the main surface fa1 of the substrate 21a. The sensor device 12a is disposed on the side surface fa2 of the substrate 21a. The sensor device 13a is disposed on the side surface fa3 of the substrate 21a.

A substrate 22b has a main surface fb1, a side surface fb2, and a side surface fb3, which are perpendicular to the Z-axis, the X-axis, and the Y-axis, respectively. The sensor device 11b is disposed on the main surface fb1 of the substrate 22b. The sensor device 12b is disposed on the side surface fb2 of the substrate 22b. The sensor device 13b is disposed on the side surface fb3 of the substrate 22b.

In variation 2, the substrate 21a is an example of a first substrate. The main surface fa1 is an example of a first surface. The side surface fa2 is an example of a second surface. The side surface fa3 is an example of a third surface. The substrate 22b is an example of a second substrate. The main surface fb1 is an example of a fourth surface. The side surface fb2 is an example of a fifth surface. The side surface fb3 is an example of the sixth surface.

As described above, the same number of sensor devices are provided for each of the X-, Y-, and Z-axes. In some embodiments, however, the number of sensor devices differs from axis to axis. For example, one sensor device for the X-axis, one sensor device for the Y-axis, and two sensor devices for the Z-axis may be provided.

As described above, the sensor module 100 according to the present embodiment produces the following effects. The sensor module 100 according to the present embodiment includes the substrate 21, the substrate 22, and the flexible substrate 40. The substrates 21 and 22 are a first substrate and a second substrate, respectively. The flexible substrate 40 is a connection portion forming a connection between the substrate 21 and the substrate 22. The substrate 21 is provided with the sensor device 11a, the sensor device 12a, and the sensor device 13a. The sensor device 11a is a first sensor device configured to detect the angular rate about the Z-axis. The angular rate about the Z-axis is a physical quantity on a first axis. The sensor device 12a is a second sensor device configured to detect the angular rate about the X-axis. The angular rate about the X-axis is a physical quantity on a second axis. The sensor device 13a is a third sensor device configured to detect the angular rate about the Y-axis. The angular rate about the Y-axis is a physical quantity on a third axis. The substrate 22 is provided with the sensor device 11b, the sensor device 12b, and the sensor device 13b. The sensor device 11b is a fourth sensor device configured to detect the angular rate about the Z-axis. The sensor device 12b is a fifth sensor device configured to detect the angular rate about the X-axis. The sensor device 13b is a sixth sensor device configured to detect the angular rate about the Y-axis.

The sensor module 100 according to the present embodiment includes two sensor devices serving as Z-axis angular rate sensors, two sensor devices serving as X-axis angular rate sensors, and two sensor devices serving as Y-axis angular rate sensors. The two respective angular rate sensors for each axis are disposed on different substrates, with one on the substrate 21 and the other on the substrate 22. This precludes the possibility of interference between the angular rate sensors for the same axis and can thus yield improvements in the effectiveness of the enhanced accuracy of the angular rate data about each axis.

The sensor device 11a and the sensor device 11b of the sensor module 100 according to the present embodiment are configured to be driven at a first driving frequency. The sensor device 12a and the sensor device 12b of the sensor module 100 according to the present embodiment are configured to be driven at a second driving frequency. The sensor device 13a and the sensor device 13b of the sensor module 100 according to the present embodiment are configured to be driven at a third driving frequency.

That is, the three angular rate sensors disposed on the substrate 21 are configured to be driven at different driving frequencies. Likewise, the three angular rate sensors disposed on the substrate 22 are configured to be driven at different driving frequencies. Thus, the angular rate sensors on the substrate 21 are less likely to interfere with each other. Likewise, the angular rate sensors on the substrate 22 are less likely to interfere with each other. This can yield improvements in the effectiveness of the enhanced accuracy of the angular rate data about each axis.

The substrate 21 of the sensor module 100 according to the present embodiment is provided with the arithmetic circuit 14 being a processing unit that is configured to perform desired processing for obtaining a mean value of the angular rate detected about the Z-axis and input to the arithmetic circuit 14 by the sensor device 11a and the sensor device 11b, a mean value of the angular rate detected about the X-axis and input to the arithmetic circuit 14 by the sensor device 12a and the sensor device 12b, and a mean value of the angular rate detected about the Y-axis and input to the arithmetic circuit 14 by the sensor device 13a and the sensor device 13b and that is configured to output results of the desired processing.

The averaging processing is performed on the basis of the angular rate detected by the sensor devices 11a, 12a, 13a, 11b, 12b, and 13b that are kept from interfering with each other. This enables the sensor module 100 according to the present embodiment to ensure the effectiveness of the enhanced accuracy.

The substrate 21 of the sensor module 100 according to the present embodiment is provided with the connector 15 for providing an external electrical connection to the sensor module 100. Given that the effectiveness of the enhanced accuracy is ensured, the sensor module 100 according to the present embodiment can output the sensing data D2 with high accuracy and reliability to the outside through the connector 15.

The substrate 21 and the substrate 22 of the sensor module 100 according to the present embodiment has the main surface f1 and the main surface f2, respectively. The main surface f1 is a first surface perpendicular to the Z-axis. The main surface f2 is a second surface perpendicular to the Z-axis and is located opposite the first main surface f1. The sensor device 11a, the sensor device 12a, and the sensor device 13a are disposed on the main surface f1. The sensor device 11b, the sensor device 12b, and the sensor device 13b are disposed on the main surface f2.

The sensor devices 11a, 12a, and 13a are disposed on the main surface f1 of the substrate 21, and the sensor devices 11b, 12b, and 13b are disposed on the main surface f2 of the substrate 22. Given that the sensor module 100 according to the present embodiment is designed as above, the sensor devices 11a, 12a, and 13a can be easily mounted onto the substrate 21, and the sensor devices 11b, 12b, and 13b can be easily mounted onto the substrate 22. The present embodiment in which the sensor module 100 is designed with ease of manufacturability provides the sensor module with added value for industrial use.

The substrate 21 of the sensor module 100 according to the present embodiment is provided with the relay substrate 25a and the relay substrate 25b. The relay substrate 25a is a first relay substrate on which the sensor device 12a is mounted. The relay substrate 25b is a second relay substrate on which the sensor device 13a is mounted. The substrate 22 of the sensor module 100 according to the present embodiment is provided with the relay substrate 25c and the relay substrate 25d. The relay substrate 25c is a third relay substrate on which the sensor device 12b is mounted. The relay substrate 25d is a fourth relay substrate on which the sensor device 13b is mounted.

That is, the sensor device 12a is disposed on the substrate 21 in the state in which the sensor device 12a is mounted on the relay substrate 25a. This provides ease of mounting of the sensor device 12a on the substrate 21, leading to increased manufacturability. The same holds true for the sensor devices 13a, 12b, and 13b. The present embodiment in which the sensor module 100 is designed with ease of manufacturability provides the sensor module with added value for industrial use.

Another feature of the sensor module 100 according to the present embodiment is as follows. The substrate 21a that is the first substrate has the main surface fa1, the side surface fa2, and the side surface fa3. The main surface fa1 is a first surface perpendicular to the Z-axis that is a first axis. The side surface fa2 is a second surface perpendicular to the X-axis that is a second axis. The side surface fa3 is a third surface perpendicular to the Y-axis that is a third axis. The substrate 22b that is the second substrate has the main surface fb1, the side surface fb2, and the side surface fb3. The main surface fa1 is a fourth surface perpendicular to the Z-axis and located opposite the main surface fa1. The side surface fb2 is a fifth surface perpendicular to the X-axis. The side surface fb3 is a sixth surface perpendicular to the Y-axis. The sensor device 11a is disposed on the main surface fa1. The sensor device 12a is disposed on the side surface fa2. The sensor device 13a is disposed on the side surface fa3. The sensor device 11b is disposed on the main surface fb1. The sensor device 12b is disposed on the side surface fb2. The sensor device 13b is disposed on the side surface fb3.

The sensor device 12a is disposed on the side surface fa2 of the substrate 21 to reduce the amount of protrusion on the main surface fa1 of the substrate 21. The same holds true for the sensor devices 13a, 12b, and 13b. The advantage of this structure is the ease with which to reduce the thickness of the sensor module 100.

The sensor module 100 according to the present embodiment includes the fixation frame 60. The fixation frame 60 is a fixation portion to which the substrate 21 and the substrate 22 are fixed. The substrate 21 and the substrate 22 are fixed to the fixation frame 60. In this way, the present embodiment enables easy and reliable fixation of the substrate 21 and the substrate 22 of the sensor module 100. The sensor module 100 according to the present embodiment can thus yield improvements in the effectiveness and reliability of the enhanced accuracy of the sensing data D1 and D2.

The sensor module 100 according to the present embodiment includes the inner case 30 and/or the outer case 50. Each of the inner case 30 and the outer case 50 is a case in which the substrate 21 and the substrate 22 can be housed. The inner case 30 and/or the outer case 50 used as a housing can reject external influence. The sensor module 100 according to the present embodiment can thus yield improvements in the effectiveness and reliability of the enhanced accuracy of the sensing data D1 and D2.

### 2. Embodiment 2

Embodiment 2 describes an electronic apparatus including the sensor module 100. A portable device (e.g., a smartphone) and a mobile object (e.g., an automobile) are described below as examples of the electronic apparatus.

### 2.1. Overview of Portable Device

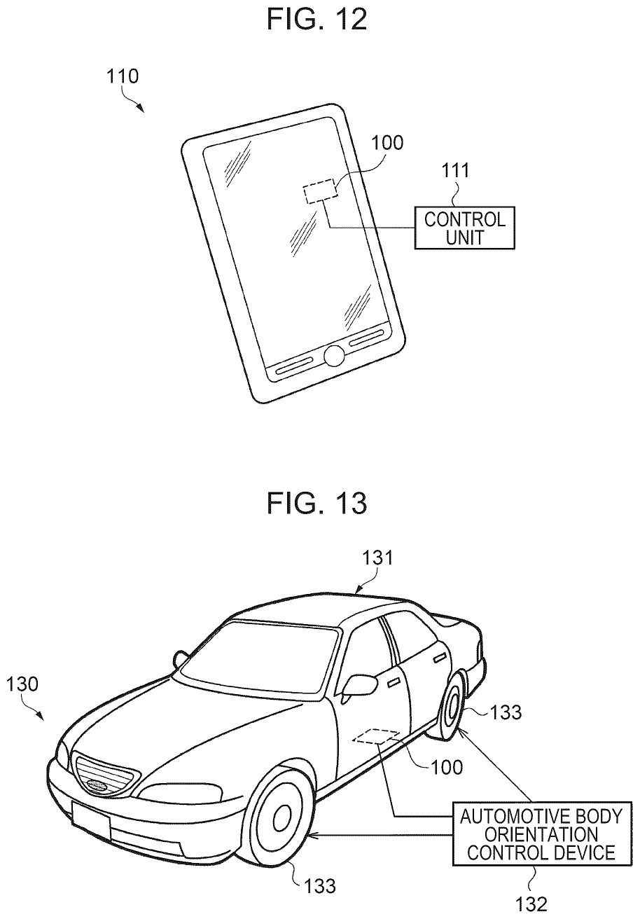

FIG. 12 is a perspective view of a portable device described below as the electronic apparatus according to Embodiment 2. The configuration of a smartphone 110, which is an example of the portable device, is illustrated in FIG. 12.

The smartphone 110 has the sensor module 100 built therein. The sensing data D2 from the sensor module 100 is received by a control unit 111. Upon receipt of signals, the control unit 111 identifies the orientation and behavior of the smartphone 110 on the basis of the signals. The control unit 111 then changes an image displayed on a display unit, produces alarm sounds or sound effects, or drives a vibration motor of the smartphone 110 to cause a main body of the smartphone 110 to vibrate.

The sensor module 100 may be built in a portable device other than the smartphone 110. For example, the sensor module 100 may be built in a portable device such as a smartwatch, a portable activity meter, a head-mounted display (HMD), a mobile personal computer (PC), a tablet PC, a camera, or a personal digital assistant (PDA). The sensing data D2 from the sensor module 100 is used to identify the orientation and behavior of the portable device, in which case the portable device changes its screen image, produces alarm sounds or sound effects, or drives a vibration motor to cause its main body to vibrate.

As described above, the portable device (e.g., the smartphone 110) in the present embodiment has the sensor module 100 built therein. Thus, the advantage of the present embodiment is the improved reliability of the portable device including the sensor module 100.

### 2.2. Overview of Mobile Object

FIG. 13 is a perspective view of a mobile object described below as the electronic apparatus according to Embodiment 2. The configuration of an automobile 130, which is an example of the mobile object, is illustrated in FIG. 13.

The automobile 130 has the sensor module 100 built therein. The sensor module 100 detects the orientation of an automotive body 131 and then transmits the sensing data D2 to an automotive body orientation control device 132. The sensing data D2 in the present embodiment includes an angular rate signal and an acceleration signal. The automotive body orientation control device 132, which is configured to control the orientation of the automotive body 131, receives the sensing data D2 from the sensor module 100 and then detects the orientation of the automotive body 131 on the basis of the signals. The automotive body orientation control device 132 controls, in accordance with the detection result, the suspension stiffness or the brakes on wheels 133.

The sensing data D2 from the sensor module 100 may also find application in keyless entry, immobilizers, car navigation systems, automobile air conditioners, anti-lock braking systems (ABS), air bags, tire pressure monitoring systems (TPMS), engine control, inertial navigation control equipment for automated driving, and electronic control units (ECUs) such as battery monitors for hybrid vehicles and electric vehicles.

The sensor module 100 may be built in a mobile object other than the automobile 130. Examples of such a mobile object include biped robots, trains, radio-controlled airplanes, radio-controlled helicopters, drones, agricultural machinery, and construction machinery. The mobile object having the sensor module 100 built therein can exploit the sensing data D2 from the sensor module 100 in, for example, the control of the orientation of the mobile object and measurements of the position of the mobile object.

As described above, the mobile object (e.g., the automobile 130) in the present embodiment has the sensor module 100 built therein. Thus, the advantage of the present embodiment is the improved reliability of the mobile object including the sensor module 100.

The present disclosure has been described on the basis of preferred embodiments but is not limited to the embodiments. Each constituent component described herein may be replaced with any element capable of performing the same functions mentioned above in relation to the embodiments and may be supplemented with any such element.

What is claimed is:

1. A sensor module comprising:
a first substrate;
a second substrate; and
a connection portion forming a connection between the first substrate and the second substrate, wherein
the first substrate is provided with a first sensor device configured to detect a physical quantity on a first axis, a second sensor device configured to detect a physical quantity on a second axis, and a third sensor device configured to detect a physical quantity on a third axis, and
the second substrate is provided with a fourth sensor device configured to detect a physical quantity on the first axis, a fifth sensor device configured to detect a physical quantity on the second axis, and a sixth sensor device configured to detect a physical quantity on the third axis.

2. The sensor module according to claim 1, wherein
the first sensor device and the fourth sensor device are configured to be driven at a first driving frequency,
the second sensor device and the fifth sensor device are configured to be driven at a second driving frequency, and
the third sensor device and the sixth sensor device are configured to be driven at a third driving frequency.

3. The sensor module according to claim 1, wherein the first substrate is provided with a processing unit that is configured to perform desired processing on the physical quantity detected on the first axis and input to the processing unit by the first sensor device and the fourth sensor device, the physical quantity detected on the second axis and input to the processing unit by the second sensor device and the fifth sensor device, and the physical quantity detected on the third axis and input to the processing unit by the third sensor device and the sixth sensor device and that is configured to output results of the desired processing.

4. The sensor module according to claim 1, wherein the first substrate is provided with a connector for providing an external electrical connection to the sensor module.

5. The sensor module according to claim 1, wherein
the first substrate has a first surface perpendicular to the first axis,
the second substrate has a second surface perpendicular to the first axis and located opposite the first surface,
the first sensor device, the second sensor device, and the third sensor device are disposed on the first surface, and
the fourth sensor device, the fifth sensor device, and the sixth sensor device are disposed on the second surface.

6. The sensor module according to claim 1, wherein
the first substrate is provided with
a first relay substrate on which the second sensor device is mounted, and
a second relay substrate on which the third sensor device is mounted, and
the second substrate is provided with
a third relay substrate on which the fifth sensor device is mounted, and
a fourth relay substrate on which the sixth sensor device is mounted.

7. The sensor module according to claim 1, wherein
the first substrate has a first surface perpendicular to the first axis, a second surface perpendicular to the second axis, and a third surface perpendicular to the third axis,
the second substrate has a fourth surface perpendicular to the first axis and located opposite the first surface, a fifth surface perpendicular to the second axis, and a sixth surface perpendicular to the third axis,
the first sensor device is disposed on the first surface,
the second sensor device is disposed on the second surface,
the third sensor device is disposed on the third surface,
the fourth sensor device is disposed on the fourth surface,
the fifth sensor device is disposed on the fifth surface, and
the sixth sensor device is disposed on the sixth surface.

8. The sensor module according to claim 1, further comprising a fixation portion to which the first substrate and the second substrate are fixed.

9. The sensor module according to claim 1, further comprising a case in which the first substrate and the second substrate are housed.

10. An electronic apparatus comprising the sensor module according to claim 1.
